(19) United States
(12) Patent Application Publication
(10) Pub. No.: US 2016/0180662 A1
(43) Pub. Date: Jun. 23, 2016

(54) METHOD, APPARATUS AND SYSTEM FOR LOCATING A TERMINAL

(71) Applicant: Anhui Huami Information Technology Co., Ltd., Hefei (CN)

(72) Inventors: Haocheng WU, Hefei (CN); Hui WANG, Hefei, Anhui (CN)

(21) Appl. No.: 14/964,089

(22) Filed: Dec. 9, 2015

(30) Foreign Application Priority Data
Dec. 17, 2014 (CN) 201410788629.7

(51) Int. Cl. G08B 7/06

(52) U.S. Cl. CPC G08B 7/06

(57) ABSTRACT

Method, apparatus and system for locating a terminal using a wearable device are set forth herein. The method includes receiving an input request for locating a terminal associated with the wearable device, and transmitting a first indication to the associated terminal to instruct the associated terminal to execute an operation of indicating a location of the terminal to a user.

### CROSS-REFERENCE TO RELATED APPLICATION

This application claims priority to Chinese patent application no. CN 201410788629.7, filed Dec. 17, 2014, which is incorporated herein in its entirety by reference.

### TECHNICAL FIELD

The present disclosure generally relates to wireless communication technologies, and more particularly, to methods, apparatuses and systems for locating a terminal such as a mobile phone.

### BACKGROUND

A user may encounter a problem in everyday life. A terminal, such as a cell phone or a tablet computer, can disappear in sight. Then, the user has to look for it, or dial the cell phone number using another phone to determine the location of the cell phone by ringing or vibrating. However, these methods for locating the terminal are not useful in scenarios where no other phone is available, when the phone signal is weak or there is no signal.

### SUMMARY

Disclosed herein are implementations of methods, devices and terminals for locating a terminal. In one aspect, the present disclosure includes a method for locating a terminal, which includes using a wearable device comprising receiving, at the wearable device, an input request for locating the terminal associated with the wearable device, and transmitting a first indication to the associated terminal, wherein the first indication is configured to instruct the associated terminal to execute an operation of indicating a location of the associated terminal to a user.

In another aspect, the present disclosure includes a method for indicating a location including receiving, at a terminal, a first indication transmitted from a wearable device associated with the terminal, wherein the first indication informs the terminal to execute an operation of indicating a location of the terminal to a user, and in response to the first indication, executing the operation of indicating the location of the terminal to the user.

In another aspect, the present disclosure includes an apparatus for locating a terminal using a wearable device comprising an acquisition module, wherein the acquisition module is configured to receive an input request for locating a terminal associated with the wearable device, and a first transmission module, wherein the first transmission module is configured to transmit a first indication to the associated terminal, wherein the first indication instructs the associated terminal to execute an operation of indicating a location of the terminal to a user.

In another aspect, the present disclosure includes a system comprising a wearable device and a terminal. The wearable device comprises a first memory and a first processor configured to execute instructions stored in the first memory to receive an input request for locating a terminal associated with the wearable device and transmit a first indication to the associated terminal, wherein the first indication instructs the associated terminal to execute an operation of indicating a location of the terminal to a user. The terminal comprises a second memory and a second processor configured to execute instructions stored in the second memory to receive the first indication transmitted from the wearable device associated with the terminal, wherein the first indication is configured to instruct the terminal to execute an operation of indicating a location of the terminal to a user, and in accordance with the first indication, execute the operation of indicating the location of the terminal to the user.

The embodiments or implementations can be configured as executable computer program instructions stored in computer storages such as memory.

### BRIEF DESCRIPTION OF THE DRAWINGS

The description here makes reference to the accompanying drawings wherein like reference numerals refer to like parts throughout the several views, and where:

FIG. 1 is a flowchart of a method for locating a terminal that can be used in a wearable device according to one implementation in this disclosure.

FIG. 2 is a flowchart of an implementation of a method for locating a terminal that can be used in a wearable device according to one implementation in this disclosure.

FIG. 3 is a flowchart of another implementation of a method for locating a terminal that can be used in a wearable device according to one implementation in this disclosure.

FIG. 4 is a flowchart of a method for locating a terminal according to one implementation in this disclosure.

FIG. 5 is a flowchart of an implementation of a method for locating a terminal according to one implementation in this disclosure.

FIG. 6 is a block diagram of a device for locating a terminal that can be used in a wearable device according to one implementation in this disclosure.

FIG. 7 is a block diagram of another device for locating a terminal that can be used in a wearable device according to one implementation in this disclosure.

FIG. 8 is a block diagram of a device for locating a terminal according to one implementation in this disclosure.

FIG. 9 is a block diagram of another device for locating a terminal according to one implementation in this disclosure.

FIG. 10 is a block diagram of a wearable device according to one implementation in this disclosure.

FIG. 11 is a block diagram of a terminal according to one implementation in this disclosure; and

FIG. 12 is a block diagram of an implementation of a method of locating a terminal that can be used in a wearable device according to one implementation in this disclosure.

### DETAILED DESCRIPTION

Example implementations of the present disclosure will be described below with reference to the accompanying drawings. The same numbers across the drawings set forth in the following description represent the same or similar elements, unless differently expressed. The implementations set forth in the following description do not represent all implementations or embodiments consistent with the present disclosure; on the contrary, they are only examples of apparatuses and methods in accordance with some aspects of this disclosure as detailed in the claims.

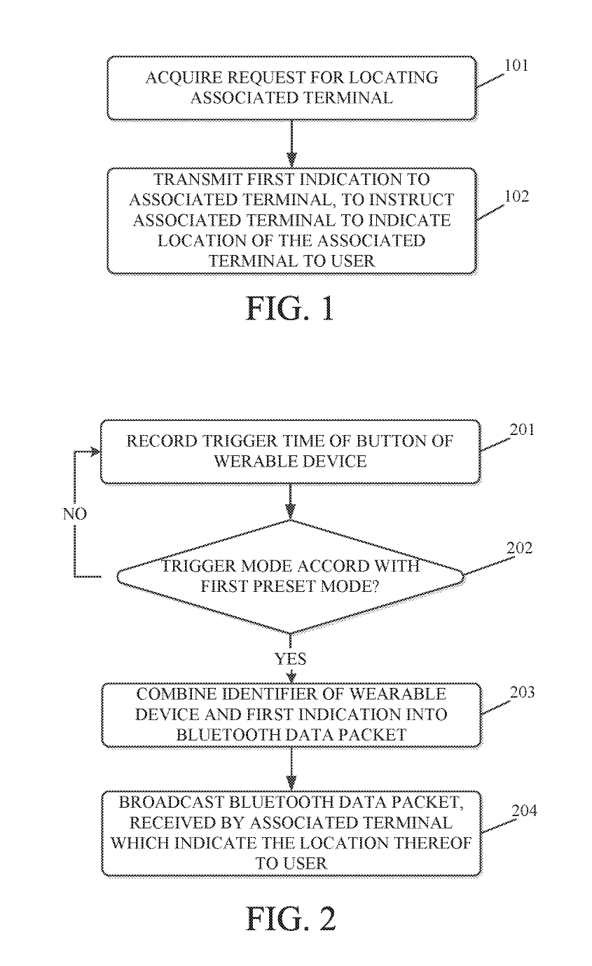

FIG. 1 is a flowchart of a method for locating a terminal using a wearable device according to one implementation, including operations 101-102 as set forth in the flowing descriptions. For example, the wearable device can be a “smart” wearable device such as a Bluetooth or wireless enabled fitness tracker module or wristband.

In this example, the wearable device is operated to locate a terminal such as a cell phone associated with the wearable device. The terminal can also be another device such as, for example, a tablet, a media player or a remote control device.

As technologies develop, wearable “smart” devices such as “smart” bracelets become more and more popular. Many users wear these bracelets on their wrists, some of them using the bracelets to monitor daily activities. A wearable device can have a button, one or more sensors such as an accelerometer or a gyroscope, and many wearable devices support connection to a terminal such as a cell phone. Therefore, this disclosure set forth a method of locating a terminal using a wearable device. For instance, a user presses a button on the wearable device, triggering the ringing and vibrating functions of the terminal to locate that terminal, which is a very convenient method for locating a terminal.

At operation 101, an input operation requesting for locating a terminal associated with the wearable device is acquired, and the operation can include an operation of triggering a preset button on the wearable device in accordance with a first preset mode, or controlling one or two of operations of moving on the wearable device in accordance with a second preset mode, or both.

At operation 102, a first indication is transmitted to the associated terminal, and the first indication can be used to instruct the associated terminal to execute an operation of indicating a location of the terminal to a user. In one implementation of this disclosure, the transmission of the first indication may be through Bluetooth or a local area network (LAN). The operation executed by the associated terminal includes, for example, one or more of the following: vibrating, ringing or lighting up a screen.

FIG. 2 is a flowchart of an implementation of a method for locating a terminal that can be used in a wearable device according to one implementation in this disclosure, where the wearable device has a button and transmits a first indication to an associated terminal via Bluetooth. The method includes operations 201-204 set forth in the following descriptions.

At operation 201, in response to the button being triggered, a trigger time of the button is recorded.

At operation 202, according to the recorded trigger time, it is determined that whether the mode of triggering the button accords with a first preset mode; if the mode thereof accords with the first preset mode, the process proceeds to operation 203; otherwise, the process ends. For instance, the first preset mode may be pressing the button for more than three seconds. For another instance, the first preset mode may be pressing the button for a preset times within a present duration, such as pressing the button for three times within 500 milliseconds, clicking the button for three times within 500 milliseconds, and so forth.

At operation 203, an identifier of the wearable device and the first indication are combined into a first Bluetooth data packet, wherein the first indication is used to instruct the associated terminal to execute an operation of indicating a location thereof to a user.

At operation 204, the first Bluetooth data packet is broadcasted. A terminal receiving the first Bluetooth data packet decodes the first Bluetooth data packet to acquire the identifier of the wearable device. If the identifier of the wearable device associates with an identifier of the terminal, the terminal is determined to be the associated terminal, wherein the associated terminal executes the operation of indicating the location thereof to the user according to the first indication. The operation thereof may include one or more of the following: vibrating, ringing or lighting up a screen.

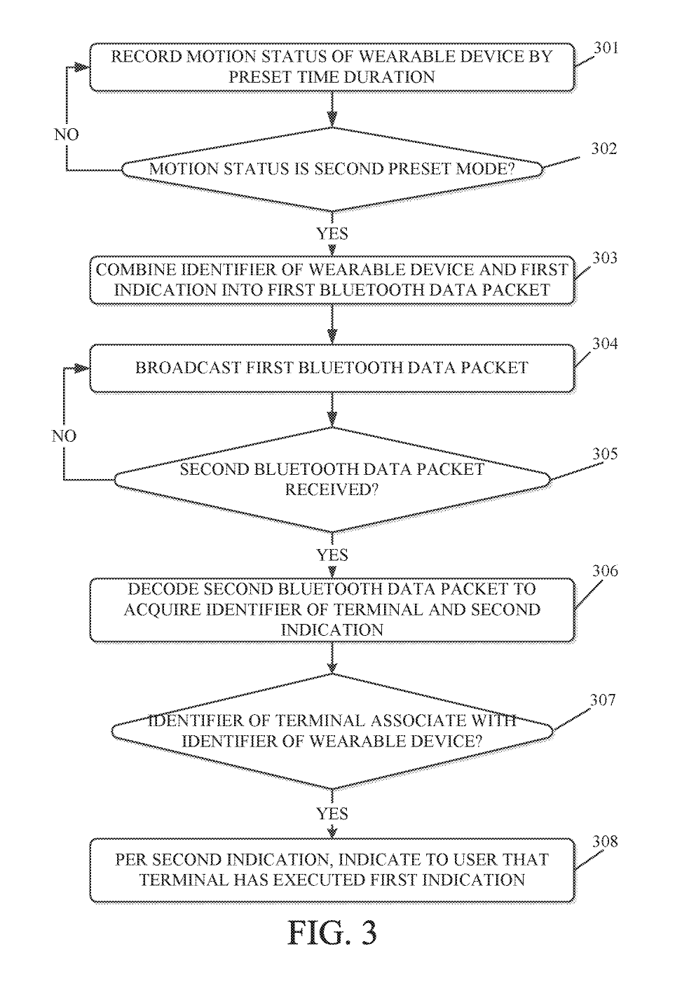

FIG. 3 is a flowchart of another implementation of a method for locating a terminal that can be implemented in a wearable device according to one implementation in this disclosure, wherein the wearable device can include one or more sensors, transmits a first indication to an associated terminal via Bluetooth, and receives a second indication sent from the associated terminal. The method includes operations 301-308 set forth in the following descriptions.

At operation 301, according to preset time duration, data of the sensor can be recorded to record the motion status of the wearable device, wherein the sensor may be an accelerometer or a gyroscope, and the sensor data may be acceleration values in directions of three axes.

At operation 302, according to the recorded data, it is determined that whether the wearable device is being controlled to move according to a second preset mode; if it is, the process proceeds to operation 303; otherwise, this operation is repeated. The second preset mode therein maybe rotating wrist for 3 times within 500 milliseconds.

At operation 303, an identifier of the wearable device and the first indication can be combined into a first Bluetooth data packet, wherein the first indication is used to instruct the associated terminal to execute an operation of indicating a location thereof to a user. A terminal receiving the first Bluetooth data packet decodes the first Bluetooth data packet to acquire the identifier of the wearable device. If the identifier of the wearable device associates with an identifier of the terminal, the terminal is determined to be the associated terminal, and the associated terminal executes the operation of indicating the location thereof to the user according to the first indication.

At operation 304, the first Bluetooth data packet is broadcasted.

At operation 305, it is determined that whether a second Bluetooth data packet is received; if the second Bluetooth data packet is received, the process proceeds to operation 306; otherwise, the process ends.

At operation 306, the received second Bluetooth data packet is decoded to acquire the identifier of the terminal which sends the second Bluetooth data packet and the second indication.

At operation 307, it is determined that whether the identifier of the terminal associates with the identifier of the wearable device; if the identifier of the terminal associates with the identifier of the wearable device, the terminal is determined to be the associated terminal of the wearable device, and the process proceeds to operation 308; otherwise, the process ends.

At operation 308, according to the second indication, an operation of indicating to the user that the terminal has executed the operation associated with the first indication, wherein the operation may include one or more of the following: vibrating, ringing or lighting up a screen. For instance, a smart bracelet with a motor may vibrate; a smart bracelet with a speaker may ring; a smart bracelet with a screen may light up. Therefore, the user knows the terminal being sought has executed the operation of indicating the location thereof to the user using the wearable device.

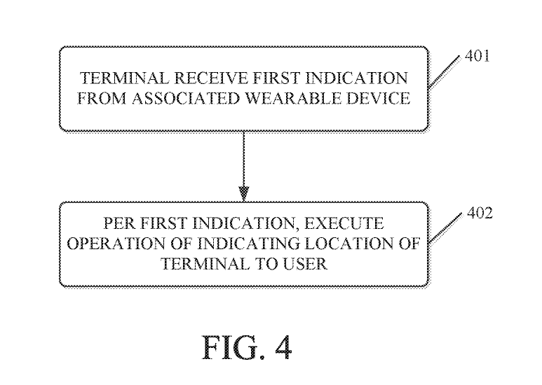

FIG. 4 is a flowchart of a method for locating a terminal used in a terminal according to one implementation in this disclosure, including operations 401-402 as set forth in the following descriptions.

At operation 401, a first indication transmitted from a wearable device associated with the terminal is received, wherein the first indication is used to indicate the terminal to execute an operation of indicating a location thereof to a user.

At operation 402, in accordance with the first indication, the operation of indicating the location thereof to the user is executed, wherein the operation may include one or more of the following: vibrating, ringing, lighting up a screen, switching on a flashlight and transmitting location information.

Therefore, this disclosure set forth a method of locating the terminal by operating the wearable device. The terminal may receive an instruction on locating a terminal from the wearable device then execute a preset operation, which is a very convenient method for locating a terminal.

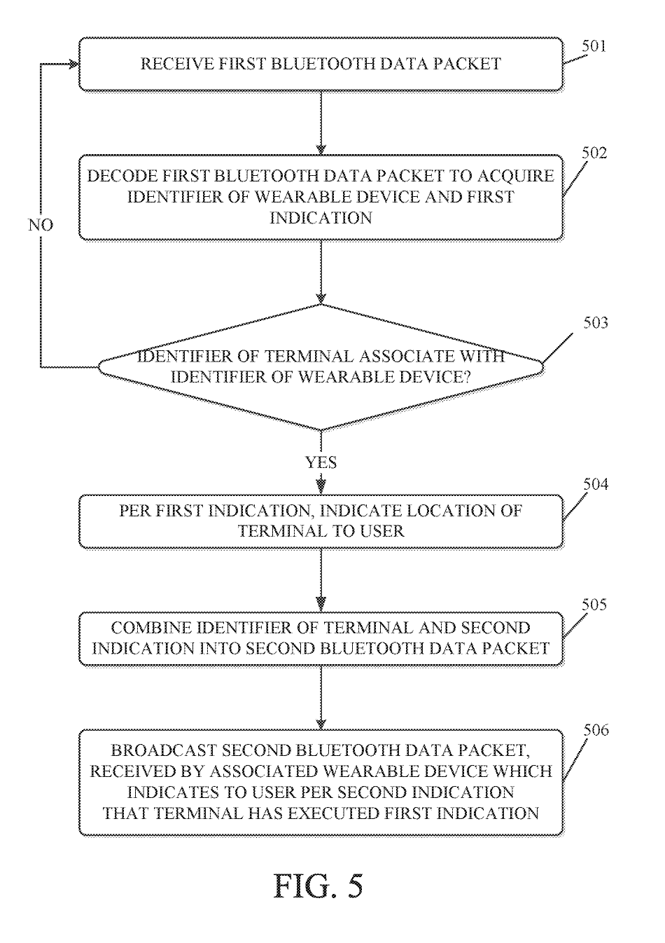

FIG. 5 is a flowchart of an implementation of a method for locating a terminal used in a terminal according to one implementation in this disclosure, wherein the terminal receives a first indication transmitted from a wearable device via Bluetooth and feeds a second indication back to the wearable device. The method includes operations 501-506 as set forth in the following descriptions.

At operation 501, a first Bluetooth data packet is received.

At operation 502, the received first Bluetooth data packet is decoded to acquire an identifier of the wearable device and a first indication, wherein the wearable device transmits the first Bluetooth data packet and the first indication is used to instruct the terminal to execute a first operation of indicating a location thereof to a user.

At operation 503, it is determined that whether the identifier of the wearable device associates with an identifier of the terminal; if the identifier of the wearable device associates with the identifier of the terminal, the process proceeds to operation 504; otherwise, the process ends. Prior to the comparison between the identifier of the wearable device and the identifier of the terminal, the wearable device and the terminal should have been paired to each other.

At operation 504, in accordance with the first indication, the first operation is executed. For instance, the terminal may vibrate, ring, light up a screen, or switch on a flashlight, wherein the transmitting location information may be sending a message to a paired wearable device with a screen.

At operation 505, the identifier of the terminal and a second indication are combined into a second Bluetooth data packet, wherein the second indication is used to instruct the wearable device to execute a second operation of indicating to the user that the associated terminal has executed the operation associated with the first indication.

At operation 506, the second Bluetooth data packet is broadcasted, wherein the wearable device receiving the second Bluetooth data packet decodes the second Bluetooth data packet to acquire the identifier of the terminal. If the identifier of the wearable device associates with the identifier of the terminal, the terminal is determined to be the associated terminal, wherein the wearable device executes the second operation according to the second indication.

Note that, in other implementations of this disclosure, the information communication between the wearable device and the terminal may use technologies of LAN, infrared, as well as Bluetooth.

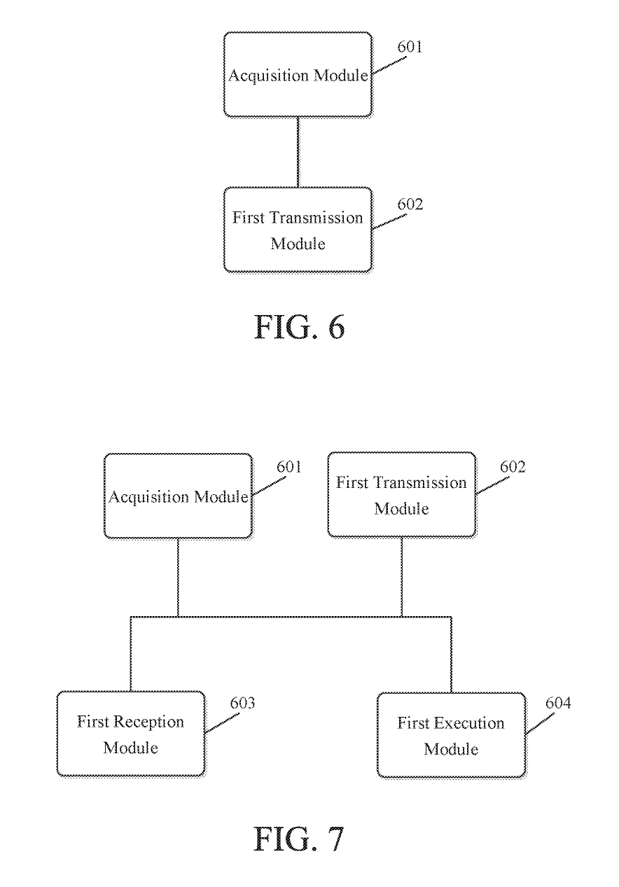

FIG. 6 is a block diagram of a device for locating a terminal that can be used in a wearable device according to implementations in this disclosure, including modules 601-602 as set forth in the following descriptions.

Acquisition module 601 acquires an input operation requesting for locating a terminal associated with the wearable device, and further acquires an operation of triggering a preset button on the wearable device in accordance with a first preset mode, and/or controlling one or more operations of moving in accordance with a second preset mode for the wearable device.

First transmission module 602 transmits a first indication to the associated terminal, wherein the first indication is used to instruct the associated terminal to execute an operation of indicating a location thereof to a user. First transmission module 602 further transmits the first indication to the associated terminal via Bluetooth or a local area network.

As illustrated in FIG. 7, the aforementioned device further includes modules set forth in the following descriptions.

First reception module 603 receives a second indication transmitted from the associated terminal, wherein the second indication is used to instruct the wearable device to execute an operation of indicating to the user that the associated terminal has executed the operation associated with the first indication.

First execution module 604 executes the operation of indicating to the user that the associated terminal has executed the operation associated with the first indication, according to the second indication; and is further used to execute one or more operations including vibrating, ringing and lighting up a screen, according to the second indication.

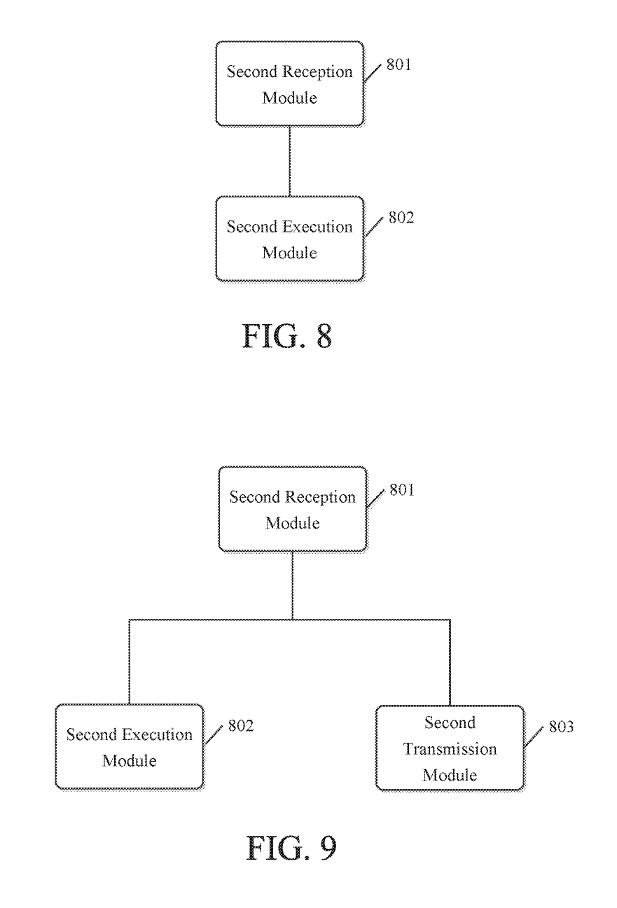

FIG. 8 is a block diagram of a device for locating a terminal used in a terminal according to implementations in this disclosure, including modules 801-802 as set forth in the following descriptions.

Second reception module 801 receives a first indication transmitted from a wearable device associated with the terminal, wherein the first indication is used to indicate the terminal to execute an operation of indicating a location thereof to a user.

Second execution module 802 executes the operation of indicating the location of the terminal to the user, according to the first indication; and is further used to execute one or more operations including vibrating, ringing, lighting up a screen, switching on a flashlight and transmitting location information, according to the first indication.

As illustrated in FIG. 9, the aforementioned device further includes second transmission module 803 which is used to transmit a second indication to the associated wearable device, wherein the second indication is used to instruct the wearable device to execute an operation of indicating to the user that the terminal has executed the operation associated with the first indication.

Note that, for locating a terminal, the devices of aforementioned implementations are merely embodied as examples by aforementioned functional modules; however, in practice, the above-mentioned functions may be distributed to and completed by different functional modules depending on practical needs, wherein the internal structures of the devices may be divided and distributed to different functional modules to complete all or part of the above-mentioned functions. In addition, the devices and methods for locating a terminal in aforementioned implementations are of the same design, wherein the concrete processes of implementations are set forth in above-mentioned examples, therefore the processes thereof are not detailed here.

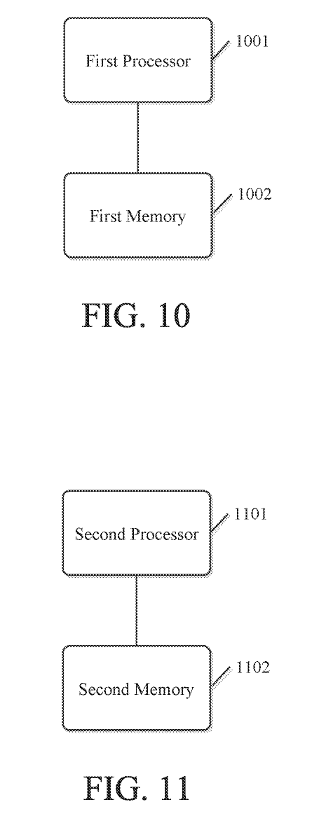

FIG. 10 is a block diagram of a wearable device according to implementations in this disclosure, including a first processor 1001 and a first memory 1002 which is used to store one or more executable instructions for first processor 1001, wherein first processor 1001 is configured to acquire an input operation requesting for locating a terminal associated with the wearable device and to transmit a first indication to the associated terminal, wherein the first indication is used to instruct the associated terminal to execute an operation of indicating a location thereof to a user.

FIG. 11 is a block diagram of a terminal according to implementations in this disclosure, including a second processor 1101 and a second memory 1102 which is used to store one or more executable instructions for second processor 1101, wherein second processor 1102 is configured to receive a first indication transmitted from a wearable device associated with the terminal, wherein the first indication is used to indicate the terminal to execute an operation of indicating a location thereof to a user, and to execute the operation of indicating the location of the terminal to the user according to the first indication. The terminal may be a cell phone, a tablet computer, a notebook computer, or another portable smart terminal.

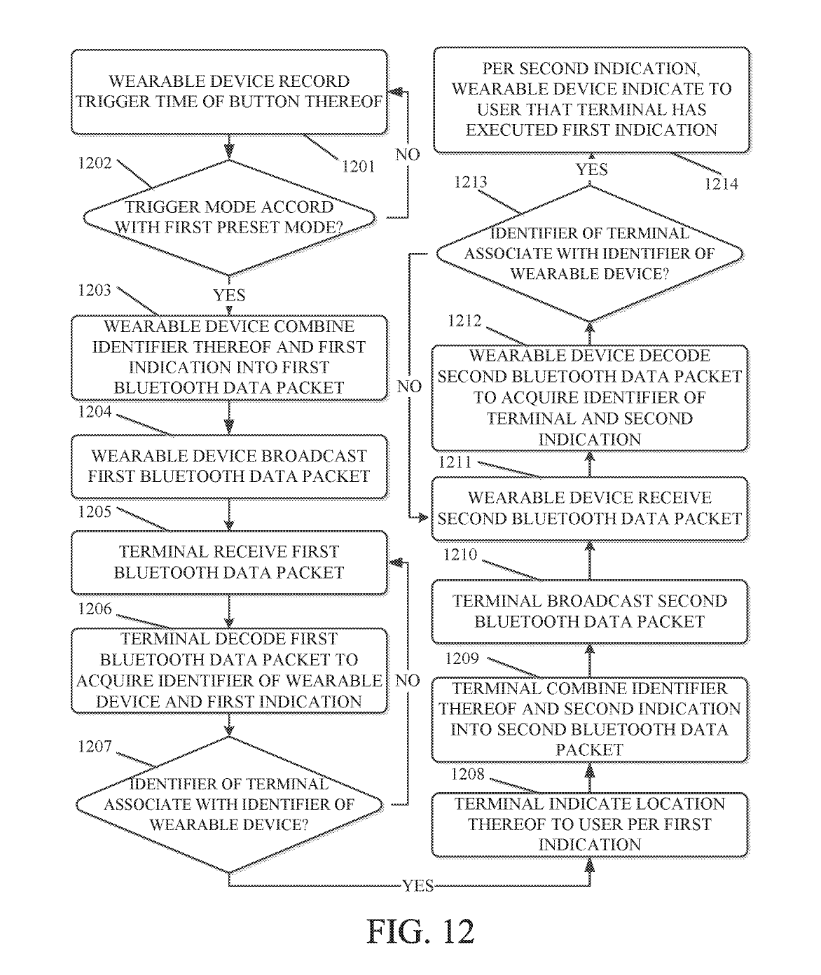

In one implementation, a method for locating a terminal executed by the above-mentioned wearable device and the terminal is set forth in the following descriptions and FIG. 12.

At operation 1201, in response to the button being triggered, the wearable device records a trigger time of the button.

At operation 1202, according to the recorded trigger time, the wearable device determines whether the mode of triggering the button accords with a first preset mode; if the mode thereof accords with the first preset mode, the process proceeds to operation 1203; otherwise, the process ends. For instance, the first preset mode may be pressing the button for more than three seconds. For another instance, the first preset mode may be pressing the button for a preset times within a present duration, such as pressing the button for three times within 500 milliseconds, clicking the button for three times within 500 milliseconds, and so forth.

At operation 1203, the wearable device combines an identifier thereof and a first indication into a first Bluetooth data packet, wherein the first indication is used to instruct the terminal to execute an operation of indicating a location thereof to a user.

At operation 1204, the wearable device broadcasts the first Bluetooth data packet.

At operation 1205, the terminal receives the first Bluetooth data packet.

At operation 1206, the terminal decodes the received first Bluetooth data packet to acquire the identifier of the wearable device and the first indication, wherein the first indication is used to instruct the terminal to execute the operation of indicating the location thereof to the user.

At operation 1207, the terminal determines whether an identifier thereof associates with the identifier of the wearable device; if the identifier of the terminal associates with the identifier of the wearable device, the process proceeds to operation 1208; otherwise, the process ends. Prior to the comparison between the identifier of the wearable device and the identifier of the terminal, the wearable device and the terminal should have been paired to each other.

At operation 1208, in accordance with the first indication, the terminal executes the operation of indicating the location thereof to the user. For instance, the terminal may vibrate, ring, light up a screen, or switch on a flashlight, wherein the transmitting location information may be sending a message to a paired wearable device with a screen.

At operation 1209, the terminal combines the identifier thereof and a second indication into a second Bluetooth data packet, wherein the second indication is used to instruct the wearable device to execute an operation of indicating to the user that the associated terminal has executed the operation associated with first indication.

At operation 1210, the terminal broadcasts the second Bluetooth data packet

At operation 1211, the wearable device receives the second Bluetooth data packet.

At operation 1212, the wearable device decodes the second Bluetooth data packet to acquire the identifier of the terminal and the second indication.

At operation 1213, the wearable device determines whether the identifier thereof associates with the identifier of the terminal; if the identifier of the wearable device associates with the identifier of the terminal, the terminal is the associated terminal of the wearable device, and the process proceeds to operation 1214; otherwise, the process ends.

At operation 1214, according to the second indication, the wearable device executes the operation of indicating to the user that the terminal has executed the operation associated with the first indication.

The devices for locating a terminal set forth in the aforementioned implementations may locate a terminal using a wearable device, which is a very convenient and practical method for locating a terminal.

For the devices in aforementioned implementations, the specific operations executed by each module have been described with details in implementations of the methods; therefore no detailed instructions will be set forth for the operations thereof herein.

Technical specialists skilled in the art should understand that, the implementations in this disclosure may be implemented as methods, systems, or computer program products. Therefore, this disclosure may be implemented in forms of a complete hardware implementation, a complete software implementation, and a combination of software and hardware implementation. Further, this disclosure may be embodied as a form of one or more computer program products which are embodied as computer executable program codes in computer writable storage media (including but not limited to read-only memory, magnetic disc and optical disc).

This disclosure is described in accordance with the methods, devices (systems), and flowcharts and/or block diagrams of computer program products of the implementations, which should be comprehended as each flow and/or block of the flowcharts and/or block diagrams implemented by computer program instructions, and the combinations of flows and/or blocks in the flowcharts and/or block diagrams. The computer program instructions therein may be provided to generic computers, special-purpose computers, embedded computers or other processors of programmable data processing devices to produce a machine, wherein the instructions executed by the computers or the other processors of programmable data processing devices produce an apparatus for implementing the functions designated by one or more flows in the flowcharts and/or one or more blocks in the block diagrams.

The computer program instructions may be also stored in a computer readable storage which is able to boot a computer or other programmable data processing device to a specific work mode, wherein the instructions stored in the computer readable storage produce a manufactured product containing the instruction devices which implements the functions designated by one or more flows in the flowcharts and/or one or more blocks in the block diagrams.

The computer program instructions may also be loaded to a computer or another programmable data processing device to execute a series of operating procedures in the computer or the other programmable data processing device to produce a process implemented by the computer, whereby the computer program instructions executed in the computer or the other programmable data processing device provide the operating procedures for the functions designated by one or more flows in the flowcharts and/or one or more blocks in the block diagrams.

Apparently, the technical specialists skilled in the art may perform any variation and/or modification to this disclosure by the principles and within the scope of this disclosure. Therefore, if the variations and modifications herein are within the scope of the claims and other equivalent techniques herein, this disclosure intends to include the variations and modifications thereof.

What is claimed is:

1. A method for locating a terminal using a wearable device, comprising:
receiving, at the wearable device, an input request for locating a terminal associated with the wearable device; and
transmitting a first indication to the associated terminal, wherein the first indication is configured to instruct the associated terminal to execute an operation of indicating a location of the associated terminal to a user.

2. The method of claim 1, wherein the receiving a an input request for locating a terminal associated with the wearable device comprises receiving at least one indication of: an operation of triggering a preset button on the wearable device according to a first preset mode, or one or more operations of controlling movement of the wearable device according to a second preset mode.

3. The method of claim 1, wherein the transmitting a first indication to the associated terminal, further comprises:
transmitting the first indication to the associated terminal via Bluetooth or a local area network.

4. The method of claim 1, wherein in response to the transmitting a first indication to the associated terminal, the method further comprises:
receiving a second indication transmitted from the associated terminal, wherein the second indication is configured to instruct the wearable device to execute an operation of indicating to the user that the associated terminal has executed the operation of indicating a location of the associated terminal to a user; and
in accordance with the second indication, executing the operation of indicating to the user that the associated terminal has executed the operation of indicating a location of the associated terminal to a user.

5. The method of claim 4, wherein in accordance with the second indication, the executing the operation of indicating to the user that the associated terminal has executed the operation of indicating a location of the associated terminal to a user further comprises:
in accordance with the second indication, executing one or more operations of: vibrating, ringing, or lighting up a screen.

6. A method for indicating a location, comprising:
receiving, at a terminal, a first indication transmitted from a wearable device associated with the terminal, wherein the first indication informs the terminal to execute an operation of indicating a location of the terminal to a user; and
in response to the first indication, executing the operation of indicating the location of the terminal to the user.

7. The method of claim 6, wherein in accordance with the first indication, the executing the operation of indicating the location of the terminal to the user comprises:
in accordance with the first indication, executing one or more operations comprising vibrating, ringing, lighting up a screen, switching on a flashlight, or transmitting location information.

8. The method of claim 6, wherein after in accordance with the first indication, the executing the operation of indicating the location of the terminal to the user further comprises:
transmitting a second indication to the associated wearable device, wherein the second indication is configured to instruct the wearable device to execute an operation of indicating to the user that the terminal has executed the operation associated with the first indication.

9. An apparatus for locating a terminal using a wearable device, comprising:
an acquisition module, wherein the acquisition module is configured to receive an input request for locating a terminal associated with the wearable device; and
a first transmission module, wherein the first transmission module is configured to transmit a first indication to the associated terminal, wherein the first indication instructs the associated terminal to execute an operation of indicating a location of the terminal to a user.

10. The apparatus of claim 9, wherein the acquisition module is further configured to:
receive at least one indication of: an operation of triggering a preset button on the wearable device according to a first preset mode, or one or more operations of controlling movement of the wearable device according to a second preset mode.

11. The apparatus of claim 9, wherein the first transmission module is further configured to:
transmit the first indication to the associated terminal via Bluetooth or a local area network.

12. The apparatus of claim 9, further comprising:
a first reception module, wherein the first reception module is configured to receive a second indication transmitted from the associated terminal, wherein the second indication instructs the wearable device to execute an operation of indicating to the user that the associated terminal has executed the operation of indicating a location of the terminal to a user; and
a first execution module, wherein in accordance with the second indication, the first execution module is configured to execute the operation of indicating to the user that the associated terminal has executed the operation of indicating a location of the terminal to a user.

13. The apparatus of claim 12, wherein the first execution module is further configured to:
in response to the second indication, execute one or more operations of: vibrating, ringing, or lighting up a screen.

14. A system, comprising:
a wearable device, comprising:
a first memory; and
a first processor configured to execute instructions stored in the first memory to:
receive an input request for locating a terminal associated with the wearable device; and
transmit a first indication to the associated terminal, wherein the first indication instructs the associated terminal to execute an operation of indicating a location of the terminal to a user; and
a terminal, comprising:
a second memory; and
a second processor configured to execute instructions stored in the second memory to:
receive the first indication transmitted from the wearable device associated with the terminal, wherein the first indication is configured to instruct the terminal to execute an operation of indicating a location of the terminal to a user; and
in accordance with the first indication, execute the operation of indicating the location of the terminal to the user.
